(19) United States
(12) Patent Application Publication
(10) Pub. No.: US 2009/0172251 A1
(43) Pub. Date: Jul. 2, 2009

(54) Memory Sanitization

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, SUNNYVALE, CA (US)

(21) Appl. No.: 12/005,259

(22) Filed: Dec. 26, 2007

(51) Int. Cl. G06F 12/02; G06F 9/455

(52) U.S. Cl. 711/103; 703/23; 711/E12.008

(57) ABSTRACT

Apparatus and method for memory sanitization is disclosed, including a memory, the memory including—in whole or in part—multiple layers of memory, and control logic configured to perform a sanitize operation on a portion of the memory. In one example, a third dimensional memory array can constitute at least a portion of the multiple layers of memory. The multiple layers of memory may include non-volatile two-terminal cross-point memory arrays. Each non-volatile two-terminal cross-point memory array can include a plurality of two-terminal memory elements that store data as a plurality of conductivity profiles that can be non-destructively determined by applying a read voltage across the terminals of the two-terminal memory element. The two-terminal memory elements retain stored data in the absence of power. The non-volatile two-terminal cross-point memory arrays can be vertically stacked upon one another and may be positioned on top of a logic plane that includes active circuitry.

### FIELD OF THE INVENTION

Various embodiments of the invention relate generally to semiconductors and memory technology. More specifically, memory sanitization is disclosed.

### BACKGROUND

In conventional memory systems, non-volatile memory can be used for applications that require instruction code and data to remain intact when a system in which the non-volatile memory resides is powered off. A non-volatile memory is a memory that retains its contents when power is removed from (i.e., not applied to) the memory. While Flash memory, a type of non-volatile memory, is used in conventional memory systems, its non-volatile nature has created problems for data-sensitive applications in business, military, and government organizations. Consequently, some of these organizations have established procedures to alter the contents of non-volatile memory so that the originally-stored data is rendered unrecognizable. The process of altering or otherwise obfuscating data in a memory is often referred to as sanitizing memory. When a memory is sanitized, the contents of the memory are altered to no longer contain the data previously held in the memory. Note that the term “data,” at least in one embodiment, can refer to either data (e.g., data bits) or datum (e.g., a data bit).

In some cases, standards have been developed that outline the requirements for memory sanitization. These requirements outline at least one sequence of programming and erase operations that are to be performed before a device is considered “sanitized.” Examples of such sequences include writing data patterns to a memory, performing erase operations, programming the memory operations, and verifying that the data has been sanitized. Since not all sanitizing standards are the same, different sequences can generally be followed to meet a variety of standards. For example, the Department of Defense outlines one set of sequences in DOD 5220.22-M for the National Industrial Security Program Operating Manual, whereas the Air Force System Security Instruction 5020 details another set of sequences. Other examples of standards that implement different sequences include the Navy Staff Office Publication 5239-based procedures, as well as the National Security Agency/Central Security Service Manual 130-2 Media Declassification and Destruction Manual. These, and other standards, provide for the sanitization of Flash memory, among other types of memory.

The various architectures of traditional non-volatile memory technologies, such as Flash memory, typically complicate the sanitization processes. For example, when sanitizing Flash memory, block boundaries limit the start and stop addresses for memory sanitization. In addition, data in a block that does not require sanitization is usually copied to another spare block while the entire block is erased, programmed with data patterns, and then verified. At the end of the sanitization process, the copied data are usually written back into the block by another program operation (e.g., a file management system). Or, a system pointer for the copied data is changed for that data. In at least one Flash-based memory architecture, the Flash memory cells are incapable of being written in both directions. As such, a Flash memory cell can be written, for example, with a logical zero (i.e., writing from a logical one (“1”) to a logical zero (“0”)). But an erase cycle, such as a block erase, typically precedes the writing of a logical zero (“0”) to a Flash memory cell storing a logical one (“1”). Thus, the foregoing process for non-volatile memory is generally restrictive, due to the block boundary limitations, and inefficient, due to movement of data which does not need to be sanitized. Note that the polarity of an erase state can be made to be represented by either a “1” or “0” by selecting the polarity of read back. Commonly, systems refer to the erase state as a “0” state, and refer to “programming” as changing the state from “0” to “1.”

There are continuing efforts to improve technology for sanitizing memory.

### BRIEF DESCRIPTION OF THE DRAWINGS

Various examples are disclosed in the following detailed description and the accompanying drawings. Although the Drawings depict various examples of the invention, the invention is not limited by the depicted examples. Furthermore, the depictions are not necessarily to scale.

FIG. 1 illustrates an exemplary memory sanitization circuit;

FIG. 2 illustrates an alternative exemplary memory sanitization circuit;

FIG. 3 illustrates an exemplary memory system;

FIG. 4 illustrates an exemplary cross-sectional view of a vertically configured non-volatile third-dimensional memory array;

FIG. 5 illustrates an exemplary memory sanitization process; and

FIGS. 6A through 6D are functional block diagrams depicting examples of memory technology-specific interfaces, according to various embodiments of the invention.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the examples has not been described in detail to avoid unnecessarily obscuring the description.

In some examples, techniques such as those described herein enable memory sanitization for a non-volatile third dimensional memory array. An exemplary non-volatile memory technology is disclosed in U.S. patent application Ser. No. 11/095,026, filed Mar. 30, 2005, and titled “Memory Using Mixed Valence Conductive Oxides,” hereby incorporated by reference in its entirety and for all purposes, describes two terminal memory cells that can be arranged in a cross-point array. The application describes a two terminal memory element that changes conductivity when exposed to an appropriate voltage drop across the two terminals. Multiple layers of the cross-point arrays may be vertically stacked upon one another to form the aforementioned vertically stacked array configuration. The memory element includes an electrolytic tunnel barrier and a mixed valence conductive oxide. The voltage drop across the electrolytic tunnel barrier causes an electrical field within the mixed valence conductive oxide that is strong enough to move oxygen ions out of the mixed valence conductive oxides and into the electrolytic tunnel barrier. Oxygen depletion causes the mixed valence conductive oxide to change its valence, which causes a change in conductivity. Both the electrolytic tunnel barrier and the mixed valence conductive oxide do not need to operate in a silicon substrate, and, therefore, can be fabricated above circuitry being used for other purposes (e.g., such as selection circuitry). The memory element stores data as a plurality of conductivity profiles that can be non-destructively determined by applying a read voltage across the terminals of the memory element. The memory element retains stored data in the absence of power. The two-terminal memory elements can be arranged in a cross point array such that one terminal is electrically coupled with an x-direction line and the other terminal is electrically coupled with a y-direction line. A stacked cross point array consists of multiple cross point arrays vertically stacked upon one another, sometimes sharing x-direction and y-direction lines between layers, and sometimes having isolated lines. When a first write voltage V_{W1} is applied across the memory element, (typically by applying ½ V_{W1} to the x-direction line and ½ −V_{W1} to the y-direction line) it switches to a low resistive state. When a second write voltage V_{W2} is applied across the memory element, (typically by applying ½ V_{W2} to the x-direction line and ½ −V_{W2} to the y-direction line) it switches to a high resistive state. Typically, memory elements using electrolytic tunnel barriers and mixed valence conductive oxides require V_{W1} to be opposite in polarity from V_{W2}.

In at least one example, a memory cell for a non-volatile third dimensional memory array does not require an erase operation before write operations and is capable of writing in both directions (e.g., “1” and “0,” or logical one and logical zero, and the like) in repeated back-to-back cycles. Thus, a memory cell for a non-volatile third dimensional memory array can be overwritten. As used herein, the term “overwrite” refers, at least in one example, to writing over a previous logical value stored in association with a memory cell, such as either writing a logical one (“1”) over a logical zero (“0”), or writing a logical zero (“0”) over a logical one (“1”). In a specific example, an overwrite operation can modify one or more bits, unlike erase operations that are typically performed at the block-level that returns the bits of a block, for example, to an erased state. Thus, the memory cells for a non-volatile third dimensional memory array facilitate memory sanitization without implementing an erase operation. Further, a sanitize operation may be done by programming only the desired memory locations, leaving the non-sanitized memory locations undisturbed. In some examples, this technique may be used with a system or controller executing the sanitize operation. In other examples, the third dimensional memory array may include a memory sanitization circuit, thereby providing the capability for memory sanitization within a single component or integrated circuit. As such, sanitization can be initiated, managed, and/or performed in-situ (e.g., without removing it from an environment for sanitization purposes).

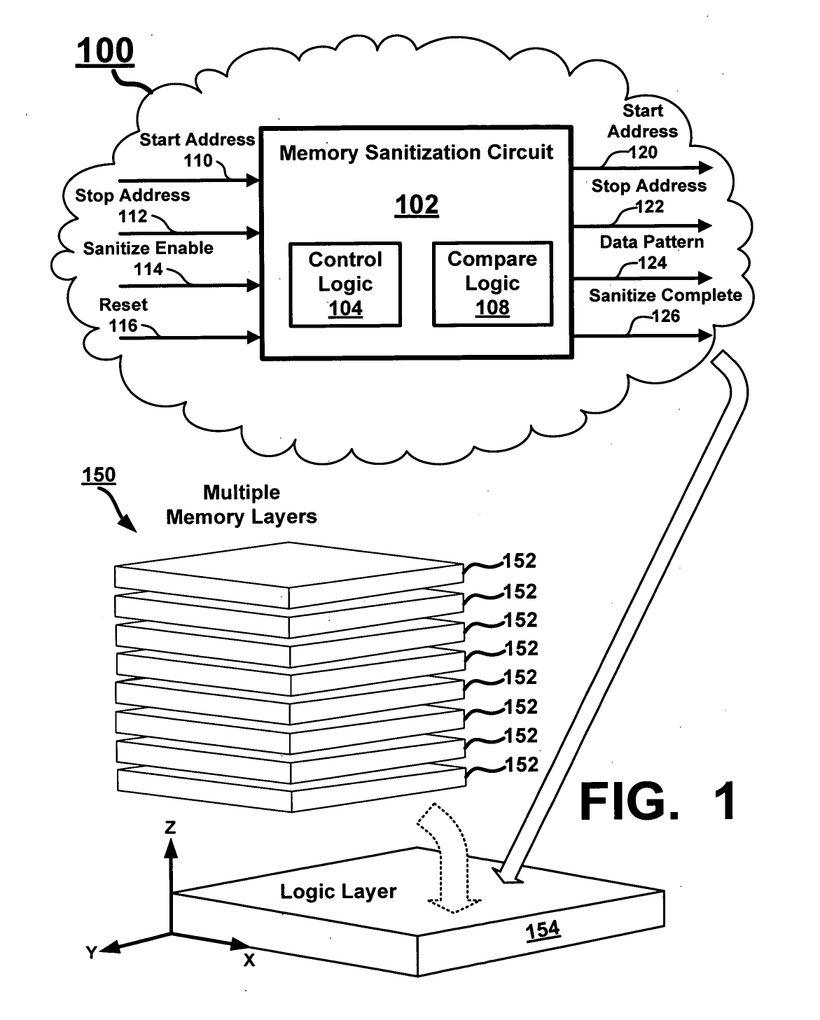

FIG. 1 illustrates an exemplary memory sanitization circuit. In this example, circuit 100 includes memory logic and memory sanitization circuit 102 that can be configured to sanitize one or more portions of a memory 150 composed of multiple layers 152 of memory cells. FIG. 1 shows multiple layers 152 being formed on top of a logic layer 154, which, in a specific example, can include memory sanitization circuit 102. Here, circuit 100 also can include control logic 104, compare logic 108, start address 110, stop address 112, sanitize enable 114, reset 116, start address 120, stop address 122, data pattern 124, and sanitize complete 126. While FIG. 1 shows control logic 104 and compare logic 108 being formed as part of the same memory sanitization circuit 102, either or both can be formed external to memory sanitization circuit 102. Although one sanitize enable 114 is shown in FIG. 1, in other examples, there may be more than one sanitize enable coupled directly or indirectly to memory sanitization circuit 102. Although one sanitize complete 126 is shown in FIG. 1, in other examples, there may be more than one sanitize complete coupled directly or indirectly to memory sanitization circuit 102. In one example, a single sanitize complete 126 and a single sanitize enable 114 can be implemented for each layer 152 of memory (or portions thereof). Further, memory sanitization circuit 102 may be designed to include more or fewer interface signals than are shown in FIG. 1.

In some examples, memory sanitization circuit 102 may contain multiple interface pins. As used herein, the term “pin” refers, at least in one example, to an interface, a terminal, a port, or any other type of input/output (“I/O”) structure configured to convey control signals, and, in some examples, refer to one or more registers for storing data representing, for example, an address, a condition (e.g., a reset condition can be set to a value indicating than an auto-sanitization is to commence upon power-up), or the like. In at least one example, one or more of the following can be implemented as one or more pins: start address 110, stop address 112, sanitize enable 114, reset 116, start address 120, stop address 122, data pattern 124, and sanitize complete 126, each of which is implemented to provide a specific functionality, as described, for example, below.

To illustrate, consider an implementation in which a host (not shown) controls a sanitation process in one example. As such, start address 110 may be configured to receive a start address for sanitization. In some examples, start address 110 may be a single pin configured to receive the address in series. In other examples, start address 110 may include a collection of pins that constitute a bus. In one example, the bus can be configured to receive bits representing a starting address in parallel. In at least one embodiment, the start address can be loaded into a register, such as a non-volatile register. An example of a non-volatile register is a register that implements a third dimensional memory. Stop address 112 may be configured to receive a stop address at which to end the sanitization process. In some examples, stop address 112 may be a single pin configured to receive the address in series. In other examples, stop address 112 may be a bus configured to receive the stop address 112 in parallel. In at least one embodiment, the stop address 112 can be stored in a register, such as a non-volatile register implementing a third dimensional memory. By indicating start address 110 and stop address 112, a system or a host (not shown) may designate where to start and stop the memory sanitization process by providing the start address and the stop address at which to begin and end, respectively, the sanitization. Start address 110 and stop address 112 may be set to any value and they are not limited by block, plane, or sub-plane boundaries. In other examples, instead of specifying start address 110 and stop address 112, two alternate signals may be specified: a signal representing a start address and a signal representing a byte or word count. By indicating a start address and a count, a system or host (not shown) may designate where to start the memory sanitization and how many bytes or words to sanitize from the starting address. In still other examples, the count may be specified by other units of measurement. In at least one embodiment, a byte count can be loaded into a register, such as a non-volatile register implementing a third dimensional memory. This count value can be loaded into a counter at the start of the sanitize operation and represents a number of bytes to sanitize.

Sanitize enable 114 may be configured to receive a signal (e.g., an activation signal) to activate the sanitize operation. In various examples, sanitize enable 114 can represent one or more sanitize enable pins. Various methods of sanitizing may be implemented. In some examples, sanitize enable 114 may be used to activate the sanitize operation, starting at start address 110 and ending at stop address 112. In other examples, a single sanitize enable 114 may be used to activate a full memory sanitization, which operates on all planes and sub-planes within the memory device. In a specific embodiment, this can be accomplished by placing the lines used for writing in an active state simultaneously, which can result in writing to the entire memory (e.g., the entire memory chip). As such, an entire memory can be sanitized by performing parallel access operations, including on or more of the following writing, reading and verifying. For example, a sanitize operation can sanitize memory cells associated with a number of memory addresses in parallel to sanitize a portion of the memory. As such, either all the memory addresses for a memory can be sanitized in parallel, or any portion thereof can be sanitized in parallel. In some embodiments, portions of the memory (e.g., subsets of memory cells, such as blocks, of a memory chip) can be activated for writing in a sequence of activations, thereby reducing power consumption as compared to writing to the entire memory at once. As used herein, the term “memory device” refers, at least in one example, to a memory card. In other examples, a memory device may be an integrated circuit. In still other examples, the memory may be divided into smaller areas of granularity, and separate sanitize enable pins may be implemented to designate plane or sub-plane that can be sanitized, as desired. Note that the activation signal can be externally-generated (i.e., external to either multiple layers of memory 150 and logic layer 154, such as by a host, or internally-generated, such as by control logic 104 formed within, for example, logic layer 154.

Reset 116 may be configured to activate the sanitize operation when the memory receives power. As such, memory 150 can be sanitized if an unauthorized user attempts to apply power to extract data stored therein. In one example, reset 116 can include a non-volatile configuration bit value representative of a reset condition, such that the value is indicative of whether an auto-sanitization process is to commence upon power-up. As such, a user can set, for example, a value for reset 116 in a non volatile register for indicate automatically sanitizing one or more portions of multiple layers of memory 150 upon power-up, thereby thwarting unauthorized persons from accessing at least portion of multiple layers of memory 150. In some examples, data representing a value for authentication purposes (e.g., data representing a password) for modifying the value of reset 116 can be stored in register including one or more non-volatile memory bits, where write access by a user is blocked to prevent revocation of an auto-sanitization process. Once reset 116 is set, power that is applied to, for example, memory sanitization circuit 102 can activate a sanitize operation (i.e., the auto-sanitization process) for memory 150 (or portions thereof). In other examples, reset 116 may be rewriteable by an authorized user. Thus, if the system is powered on by an authorized user, reset 116 may be turned off and no sanitization would occur. In still other examples, reset 116 may be rewriteable when a password comparison is active. This may be implemented by storing a password in a non-volatile memory location within, for example, memory 150 and comparing it against the entered password before allowing a configuration bit for rest 116 to be altered.

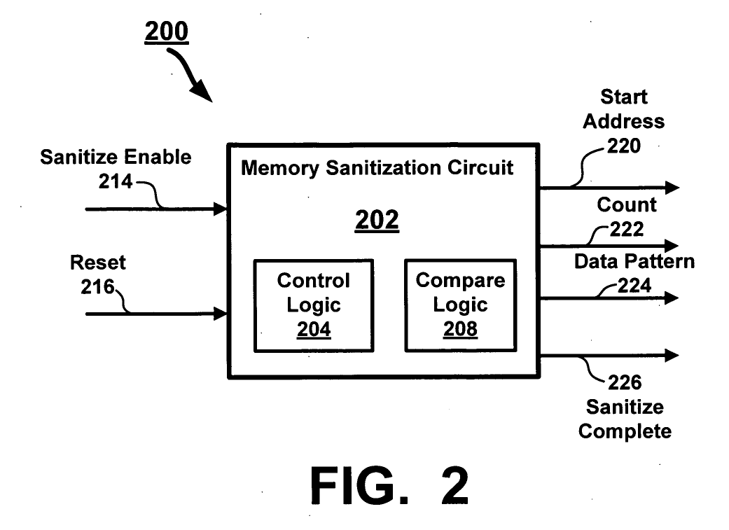

To illustrate operation of circuit 100, consider an implementation in which memory sanitization circuit 102 is configured to initiate, manage, and/or perform in-situ sanitization. For example, start address 120 may be configured to indicate a start address for sanitization. In some examples, start address 120 may be a single pin configured to indicate the address in series. In other examples, start address 120 may be a bus configured to indicate the address in parallel. Stop address 122 may be configured to indicate a stop address for sanitization. In some examples, stop address 122 may be a single pin configured to indicate the address in series. In other examples, stop address 122 may be a bus configured to indicate the address in parallel. By indicating start address 120 and stop address 122, memory sanitization circuit 102 may designate where to start and stop the memory sanitization. Start address 120 and stop address 122 may be set to any value and they are not limited by block, plane, or sub-plane boundaries. In other examples, instead of specifying start address 120 and stop address 122, two alternate signals may be specified: a start address and a byte or word count. By indicating a start address and a count, memory sanitization circuit 102 may designate where to start the memory sanitization and how many bytes or words to sanitize starting from that address. In still other examples, a count, such as provided by count 222 (FIG. 2), may be specified by other units of measurement, such as a value stored in non-volatile registers, which can be internal to circuit 100.

Data pattern 124 may be configured to indicate the desired data pattern used for sanitization. In some examples, data pattern 124 may be generated by memory sanitization circuit 102 in accordance with the requirements of a specific sanitization sequence designed to sanitize multiple layers 152 of memory, such as third dimensional memory array. Data pattern 124 can include any number of bits having any number of logical states. In operation, memory sanitization circuit 102 is configured to generate one or more data patterns 124 for overwriting into memory 150 for sanitization purposes. In other examples, data pattern 124 may be all logical ones (e.g., each data bit is a “1”), all logical zeros (e.g., each data bit is a “0”), checkerboard patterns (e.g., hexadecimal “AA” or “55”), or any combination of logical-valued data bits. Sanitize complete 126 may be configured to indicate when the sanitize operation is complete. As such, a host (not shown) or control logic 104 can detect the completion of the sanitization operation via sanitize complete 126 to, for example, permit access to multiple layers 152 of memory.

In some examples, data for sanitize complete 126 may be stored as an internal register with a non-volatile memory bit, such as in memory 150. The internal register can set (e.g., logical one or “1”) to represent indicating whether sanitize operation is complete for communication via sanitize complete 126. In some examples, the value stored in the internal register for sanitize complete 126 may be reset (e.g., logical zero or “0”) by a system write to the internal register, which may reside in memory 150. As used herein, the term “system write” refers, at least in one example, to a write operation executed by a host controller. In other examples, system write may refer to a write operation executed by any system that implements memory sanitization circuit 102. In other examples, the internal register for sanitize complete 126 may be reset by memory sanitization circuit 102 at the completion of the sanitize operation and deactivation of sanitize enable 114. In some examples, there may be separate sanitize complete pins for each plane or sub-plane of memory. As used herein, the term “plane of memory” can refer, at least in one example, to a layer of memory, whereas the term “sub-plane of memory” can refer to a portion of a layer of memory. In other examples, there may be a single register for a single sanitize complete 126—as a global sanitize complete—that may be set at the completion of all of the sanitize operations that were activated, thereby indicating that each pending sanitization operation, concurrent or otherwise, has ended.

In some examples, memory sanitization circuit 102 may be configured to include multiple blocks of logic configured for interfacing with a host (not shown) and controlling memory. In FIG. 1, control logic 104 is configured to receive input signals, as described above, and control memory 150 (and accesses thereto) as well as the sanitize operation. Compare logic 108 is configured to verify that desired areas of memory 150 have been sanitized properly. In one example, compare logic 108 is configured to compare data in the memory to the desired data pattern for verification. Memory sanitization circuit 102 may be configured to recall its progress in the sanitization operation until the sanitization is complete, regardless of power cycling. By having a memory complete its sanitize sequence once it has started, regardless of power cycles (i.e., power-up and power-down conditions), the memory can be guaranteed to be sanitized by memory sanitization circuit 102. Upon completion of the sanitization process, a status complete signal is provided, and normal read and write accesses can be permitted. In other examples, circuit 100 and the above-described elements may be varied and are not limited to the functions, structures, configurations, or implementations provided.

FIG. 2 illustrates an alternative exemplary memory sanitization circuit for implementing memory sanitization within a memory device (not shown) implementing memory sanitization circuit 202. Here, circuit 200 includes memory sanitization circuit 202, control logic 204, compare logic 208, sanitize enable 214, reset 216, start address 220, count 222, data pattern 224, and sanitize complete 226. In at least one example, one or more of the following can be implemented as one or more pins: sanitize enable 214, reset 216, start address 220, stop address 222, data pattern 224, and sanitize complete 226, each of which is implemented to provide a specific functionality, as described, for example, below. Control logic 204 and compare logic 208 may be formed on the same memory sanitization circuit 202. Although one sanitize enable 214 is shown in FIG. 2, in other examples, there may be more than one sanitize enable coupled directly or indirectly to memory sanitization circuit 202. Although one sanitize complete 226 is shown in FIG. 2, in other examples, there may be more than one sanitize complete coupled directly or indirectly to memory sanitization circuit 202. Further, memory sanitization circuit 202 may be designed to include more or fewer interface signals than shown in FIG. 2.

In some examples, memory sanitization circuit 202 may include multiple interface pins. In this example, memory sanitization circuit 202 may be incorporated in the memory device. Here, memory sanitization does not require a system or host to execute the sanitize operation. Instead, memory sanitization circuit 202 may execute the sanitize operation independently. Memory sanitization circuit 202 may generate the addresses and data patterns needed to sanitize the desired areas of memory.

Sanitize enable 214 may be configured to receive a signal to activate the sanitize operation. Various methods of sanitizing may be implemented. In some examples, a single sanitize enable 214 may be used to activate a full memory sanitization, operating on all planes and/or sub-planes within the memory device. In other examples, the memory (not shown) may be divided into smaller areas of granularity and separate sanitize enable pins may be designated for each plane or sub-plane, as desired. Reset 216 may be configured to activate the sanitize operation when the memory receives power. In some examples, data for a configuration bit for reset 216 may be stored in a non-volatile memory bit (e.g., in a register, for example, in a portion of multiple layers of memory 150 (FIG. 1)) where write access is blocked. Once the data for reset 216 is set, a power on (e.g., when power is applied to circuit 200 or to the system in which circuit 200 resides) can activate a sanitize operation for the entire memory (or portions thereof). In other examples, a register (not shown) for reset 216 may be rewriteable by an authorized user. Thus, if the system is powered on by an authorized user, the data value in the register for reset 216 may be turned off (i.e., reset) so that the sanitization process would be disabled. In still other examples, the data stored in the register for reset 216 may be rewriteable when a password comparison is active. This may be implemented by storing a password in a non-volatile memory location and comparing it against the entered password before allowing the data relating to reset 216 to become altered.

Start address 220 may be configured to indicate a start address for sanitization. In some examples, start address 220 may be a single pin configured to indicate the address in series. In other examples, start address 220 may be a bus configured to indicate the address in parallel. Count 222 may be configured to indicate a byte or word count, specifying how many bytes or words to sanitize starting from start address 220. By indicating start address 220 and count 222, memory sanitization circuit 202 may designate where to start the memory sanitization and how many bytes or words to sanitize starting from that address. In other examples, the count may be specified by other units of measurement. In still other examples, instead of using count 222, a stop address may be used to indicate a stopping point for sanitization. In some examples, the stop address may be a single pin configured to indicate the address in series. In other examples, the stop address may be a bus configured to indicate the address in parallel. By using start address 220 and a stop address, memory sanitization circuit 202 may designate where to start and stop the memory sanitization. Start address 220 and the stop address may be set to any value and they are not limited by block, plane, or sub-plane boundaries.

Data pattern 224 may be configured to indicate the desired data pattern used for sanitization. In some examples, data pattern 224 may be determined by the specific requirements of a given sanitization standard. In other examples, data pattern 224 may be all logical ones (e.g., each data bit is a “1”), all logical zeros (e.g., each data bit is a “0”), or a combination of logical ones and zeros. Sanitize complete 226 may be configured to indicate when the sanitize operation is complete. In some examples, data for sanitize complete 226 may be stored as an internal register in a non-volatile memory bit. Sanitize complete 226 may be set (e.g., logical one or “1”) when the sanitize operation is complete. In some examples, sanitize complete 226 may be reset (e.g., logical zero or “0”) by a system write to the internal register. In other examples, the data for sanitize complete 226 may be reset by completion of the sanitize operation and deactivation of sanitize enable 214. In some examples, there may be separate sanitize complete pins for each plane or sub-plane of memory. In other examples, there may be a single, global sanitize complete 226 that may be set at the completion of all sanitize operations that are activated.

While FIG. 2 shows memory sanitization circuit 202 being configured to operate independent from a host, in some examples, memory sanitization circuit 202 may be configured to include multiple blocks of logic configured for both interfacing with the host and controlling memory. In FIG. 2, control logic 204 is configured to receive input signals, as described above, and control memory and the sanitize operation. Compare logic 208 is configured to verify that desired areas of memory have been sanitized properly. Compare logic 208 compares data in the memory to the desired data pattern for verification. Memory sanitization circuit 202 may be configured to recall its progress in the sanitization operation until the sanitization is complete, regardless of power cycling. In other examples, circuit 200 and the above-described elements may be varied and are not limited to the functions, structures, configurations, or implementations provided.

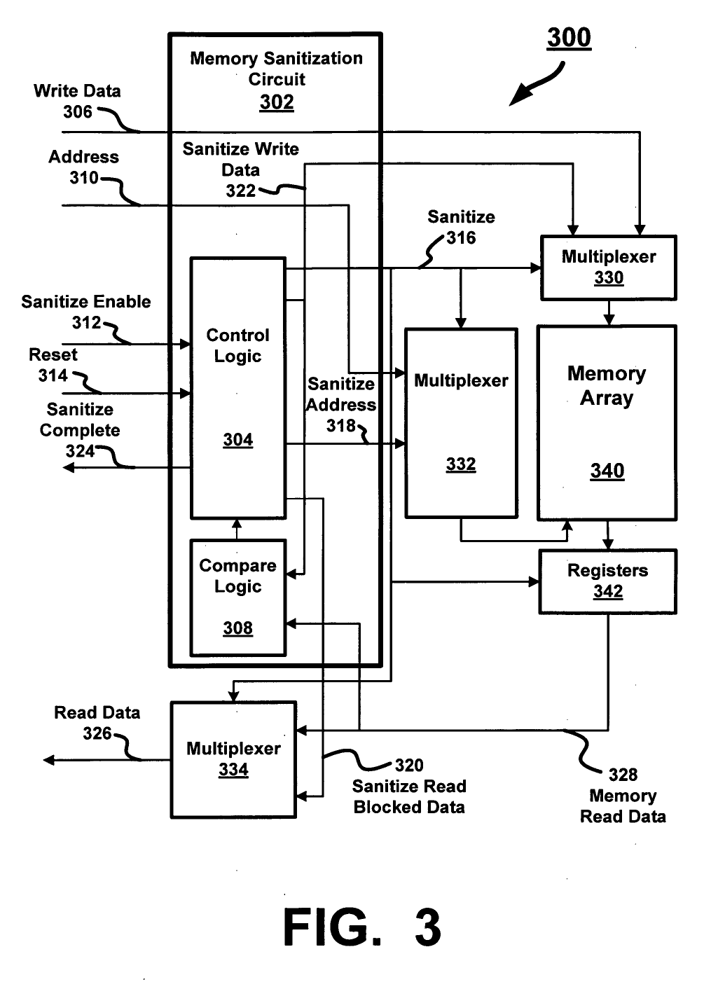

FIG. 3 illustrates an exemplary memory system. Here, system 300 includes memory sanitization circuit 302, control logic 304, compare logic 308, write data 306, address 310, sanitize enable 312, reset 314, sanitize 316, sanitize address 318, sanitize read blocked data 320, sanitize write data 322, sanitize complete 324, read data 326, memory read data 328, multiplexers 330-334, memory array 340, and registers 342. While FIG. 3 shows that control logic 304 and compare logic 308 being formed within same memory sanitization circuit 302, either or both can be formed without. Although one sanitize enable 312 is shown in FIG. 3, in other examples, there may be more than one sanitize enable coupled directly or indirectly to memory sanitization circuit 302. Although one sanitize complete 324 is shown in FIG. 3, in other examples, there may be more than one sanitize complete coupled directly or indirectly to memory sanitization circuit 302. Further, memory sanitization circuit 302 may be designed to include more or fewer interface signals than shown in FIG. 3.

In some examples, memory sanitization circuit 302 may contain multiple interface pins. Address 310 may be configured to receive a memory address to read or write. In some examples, address 310 may be a single pin configured to receive the address in series. In other examples, address 310 may be a bus configured to receive the address in parallel. Write data 306 may be configured to receive data to be written under normal operation (e.g., when the sanitize operation is not activated). Read data 326 may be configured to output read data from memory, such as from memory array 340. Sanitize enable 312 may be configured to receive a signal to activate the sanitize operation. Various methods of sanitizing may be implemented. In some examples, sanitize enable 312 may be used to activate a full memory sanitization, operating on all planes and sub-planes within the memory device. In other examples, the memory may be divided into smaller areas of granularity and separate sanitize enable pins may be designated for each plane or sub-plane, as desired. Reset 314 may be configured to activate the sanitize operation when the memory receives power. In some examples, reset 314 may be stored in a non-volatile memory bit where write access is blocked. Once reset 314 is set, a power on can activate a sanitize operation for the entire memory. In other examples, reset 314 may be rewriteable by an authorized user. Thus, if the system is powered on by an authorized user, reset 314 may be turned off and no sanitization would occur. In still other examples, reset 314 may be rewriteable when a password comparison is active. This may be implemented by storing a password in a non-volatile memory location and comparing it against the entered password before allowing reset 314 to be altered. Sanitize complete 324 may be configured to indicate when the sanitize operation is complete. In some examples, sanitize complete 324 may be stored as an internal register in a non-volatile memory bit. Sanitize complete 324 may be set (e.g., logical one or “1”) when the sanitize operation is complete. In some examples, sanitize complete 324 may be reset (e.g., logical zero or “0”) by a system write to the internal register. In other examples, sanitize complete 324 may be reset by completion of the sanitize operation and deactivation of sanitize enable 312. In some examples, there may be separate sanitize complete pins for each plane or sub-plane of memory. In other examples, there may be a single sanitize complete 324 that may be set at the completion of all sanitize operations that were activated.

In some examples, memory sanitization circuit 302 may be configured to include multiple blocks of logic configured for interfacing with a host and controlling memory. In FIG. 3, control logic 304 is configured to receive input signals, as described above, and control memory and the sanitize operation. Compare logic 308 is configured to verify that desired areas of memory have been sanitized properly. Compare logic 308 compares memory read data 328 to sanitize write data 322 for verification. Memory sanitization circuit 302 may be configured to recall its progress in the sanitization operation until the sanitization is complete, regardless of power cycling.

As an example, a sanitize operation may be initiated by setting sanitize enable 312. Control logic 304 is configured to receive sanitize enable 312, and to control multiplexers 330-334 accordingly. Control logic 304 generates sanitize control signal (“sanitize”) 316, which causes multiplexers 330-334 to select data for the sanitize operation (e.g., if sanitize 316 is set) or for normal operation (e.g., if sanitize 316 is not set). For the sanitize operation, sanitize write data 322 may be configured to indicate the desired data pattern used for sanitization. In some examples, sanitize write data 322 may be determined by the specific requirements of a given sanitization standard. In other examples, sanitize write data 322 may be all logical ones (e.g., each data bit is a “1”) or all logical zeros (e.g., each data bit is a “0”). Thus, during the sanitize operation, multiplexer 330 sends sanitize write data 322 to memory array 340; during normal operation, multiplexer 330 sends write data 306 to memory array 340. For the sanitize operation, sanitize address 318 may be configured to indicate the address for sanitization. In some examples, sanitize address 318 may be a single pin configured to indicate the address in series. In other examples, sanitize address 318 may be a bus configured to indicate the address in parallel. During the sanitize operation, multiplexer 332 sends sanitize address 318 to memory array 340; during normal operation, multiplexer 332 sends address 310 to memory array 340. Data read from the memory may be blocked (e.g., data may be all logical ones, all logical zeros, or tri-stated) until the sanitize operation is complete. In some examples, if multiple sanitize segments are implemented, then reads from the entire memory may be blocked until the sanitize operation is complete. As used herein, a “sanitize segment” refers, at least in one example, to a segment of memory defined by a start address and a stop address. Multiple sanitize segments may be defined by multiple pairs of start and stop addresses. In other examples, if multiple sanitize segments are implemented, reads may be blocked only from areas where the sanitize operation has not completed. In still other examples, if multiple sanitize segments are implemented, internal registers may store status bits for each sanitized area. Data read from memory array 340 is passed to registers 342. Registers 342 pass the data, memory read data 328, to multiplexer 334 and compare logic 308. Thus, during the sanitize operation, multiplexer 334 sends sanitize read blocked data 320 as read data 326; during normal operation, multiplexer 334 sends memory read data 328 as read data 326. Compare logic uses memory read data 328 to compare against sanitize write data 322 for verification and passes the result to control logic 304. In other examples, system 300 and the above-described elements may be varied and are not limited to the functions, structures, configurations, or implementations provided.

FIG. 4 illustrates an exemplary cross-sectional view of a vertically configured non-volatile third-dimensional memory array. In some examples, memory array 400 includes memory logic 402, which may be vertically configured with one, two, three, or multiple (i.e., “n”) memory array layers 404-410. Each of memory array layers 404-410 may be used for implementing different aspects of a memory system (e.g., system 300 (FIG. 3), and others). For example, a base layer of memory array 400 (e.g., memory array layer 402) may be used to implement control logic or compare logic (e.g., control logic 304 (FIG. 3), compare logic 308 (FIG. 3), and the like), while memory array layers 404-410 may be used to implement memory. Further, memory array layers 404-410 may be used to implement ‘n’ number of memory types, where each of memory array layers 404-410 are configured to emulate a different type of memory (e.g., SRAM, DRAM, NOR, NAND, Flash, and others). Still further, each of memory array layers 404-410 may be configured, formed, fabricated, or otherwise implemented entirely or partially to emulate a memory type. In other examples, memory array layers 404-410 may be implemented as the same memory type. In still other examples, the number of memory array layers 404-410 may be varied to include more, fewer, or different layers than those shown and described.

As an example, logic (e.g., memory sanitization circuit 302 (FIG. 3)) may be formed in memory array layer 402. Internal registers used for the sanitize operation may be stored in memory array layer 404. In some examples, internal registers may include sanitize bits, passwords, sanitize complete bits, and other internal registers as described above. Further, memory array 340 (FIG. 3) may be formed in memory array layer 406. In other examples, more, fewer, or different layers than those shown may be used. In still other examples, system 400 and the above-described elements may be varied and are not limited to the functions, structures, configurations, or implementations provided.

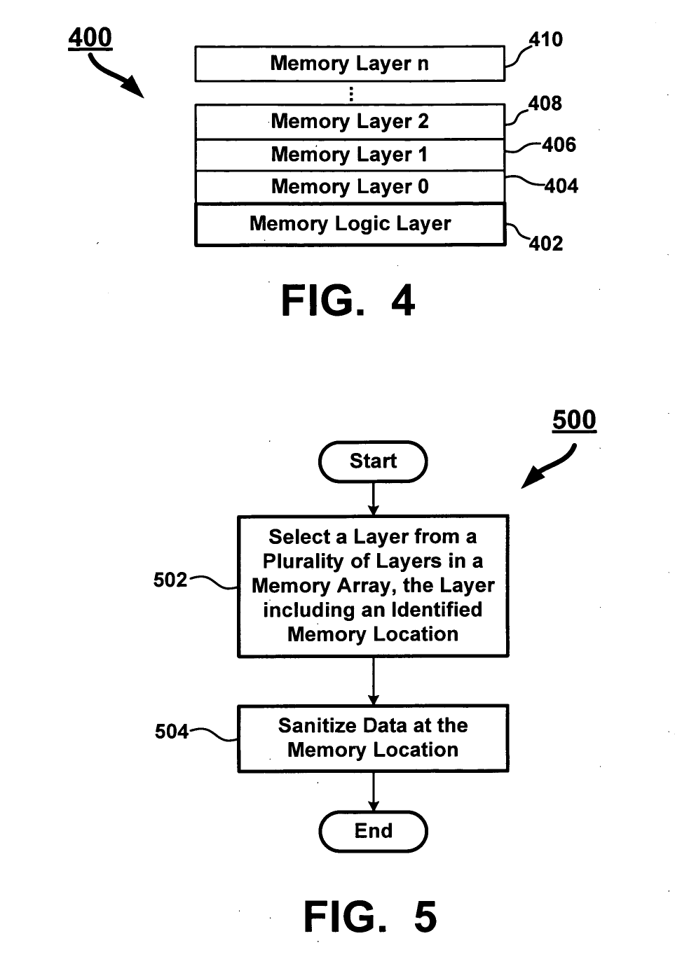

FIG. 5 illustrates an exemplary memory sanitization process. Here, process 500 starts by selecting a layer from a plurality of layers in a memory array, the layer including an identified memory location (502). In some examples, the memory array may be a third dimensional memory array. Once a layer is selected, data at the memory location included in the layer is sanitized (504). In some examples, sanitizing includes overwriting data at the memory location with, for example, a character, the complement of the character, and/or a random character, in succession, and without an intervening memory access operation (e.g., an operation requiring access to a memory location, such as a read, a write or an erase operation). In one example, the intervening memory access operation refers to an erase operation. As used here, the term “character” may refer, at least in one example, to a collection of bits (e.g., one or more bytes), which, in some cases, represents an ASCII character. As used here, “overwriting” may refer, at least in one example, to overwriting with sanitized data. In other examples, overwriting may refer to replacing with sanitized data. In still other examples, sanitizing further includes verifying the data at the memory location is sanitized. In yet other examples, the above-described process may be varied and is not limited to the processes or sub-processes described above.

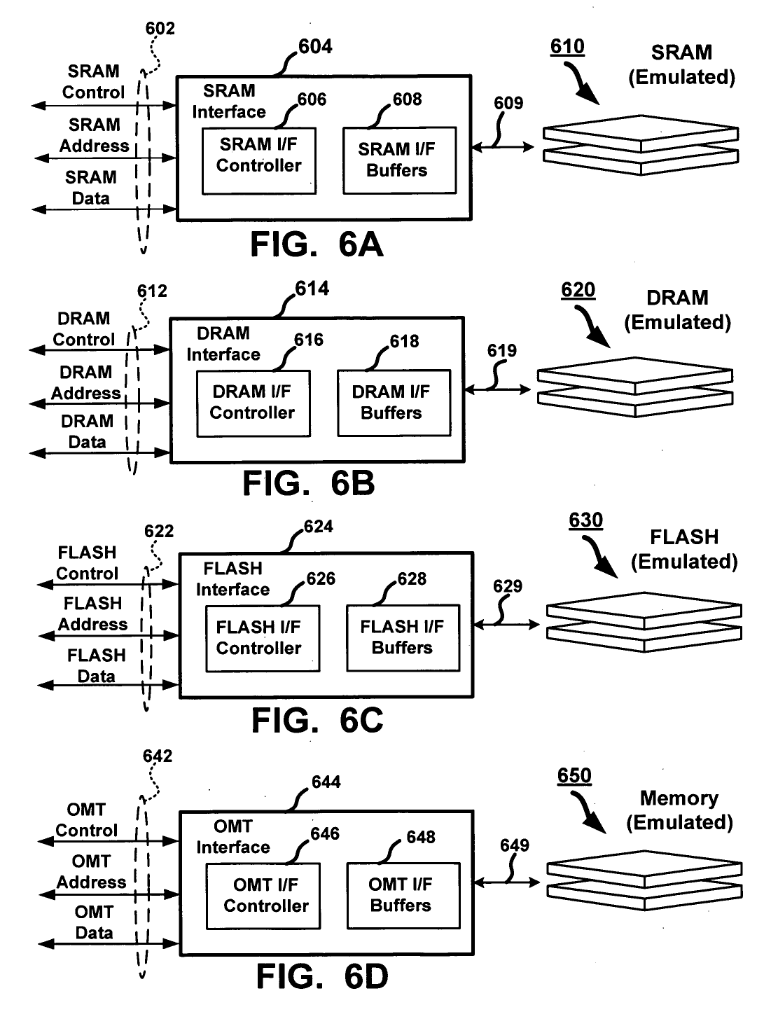

FIGS. 6A through 6D are functional block diagrams depicting examples of memory technology-specific interfaces, according to various embodiments of the invention. As third dimension memory cells can be written to and read from at speeds comparable to, or faster than, various known memory technologies, one or more layers 610, 620, 630, and 650 can emulate various technologies. In implementations in which third dimension memory cells are used to emulate other memory technologies, those emulated memories can be implemented with memory sanitization circuit 102 to sanitize the emulated memory, such as an emulated Flash memory for an emulated Flash memory-based memory device.

Third dimension memory cells can have access times equivalent to 8 to 12 nanoseconds, or less, according to at least one embodiment. As such, one or more layers 610 of third dimension memory cells can provide for a “nonvolatile” SRAM, which can conserve power that otherwise would be used to maintain data in a conventional SRAM. Further, third dimension memory elements (or cells) can emulate SRAM memory cells without NAND and NOR gates as memory elements. This increases the density of the emulated SRAM. Typically, SRAM technologies use four to six transistors operating as flip flops. In one embodiment, memory technology-specific interfaces include an interface (“I/F”) controller and optional interface buffers. In a specific embodiment, the interface controller includes logic formed in a logic subsystem (e.g., in logic layer 154 of FIG. 1) and interface buffers formed in a memory subsystem (e.g., in one or more memory layer 152 of FIG. 1).

FIG. 6A shows a memory technology-specific interface as an SRAM interface 604 that is configured to use one or more layers 610 of third dimension memory cells to emulate SRAM memory technology. In particular, SRAM interface 604 operates to convert SRAM signals 602 into signals 609 for interacting with one or more layers 610. SRAM signals 602 can include SRAM control signals, such as a chip select and write enable signals (neither are shown), address signals representing an address and data signals representing data either written into or read from one or more layers 610, which emulates SRAM.

SRAM interface 604 includes an SRAM interface (“I/F”) controller 606 and optional SRAM interface (“I/F”) buffers 608. SRAM interface controller 606 can include logic configured to use SRAM control signals to determine whether layers 610 of the emulated SRAM memory cells are to be written or read. An example of such logic includes decode logic for determining whether to write a byte of memory based on a chip select signal and a write enable signal. SRAM interface controller 606 can optionally include additional logic that is configured to, for example, coordinate the conversion of SRAM data and address signals into data and address signals 609 that are useable by memory arrays of third dimension memory cells in layers 610. As such, the additional logic can convert addresses in two-dimension memory space into addresses for three-dimension memory space. SRAM interface buffers 608, which can be optional, can include temporary storage (e.g., using third dimension memory cells) for converting serially transmitted address and/or data signals, if applicable, into parallel address and/or data signals, or vice versa. In view of the foregoing, SRAM interface 604 enables layers 610 to emulate, for example, a cache memory at any of the vertically-stacked layers of memory. This saves memory array space that otherwise would contribute to an increase in die size. In various embodiments, memory cells emulating SRAM can share space in the same layer as a logic subsystem, or in any plane above that subsystem.

FIG. 6B shows a memory technology-specific interface as a DRAM interface 614 that is configured to use one or more layers 620 of third dimension memory cells to emulate DRAM memory technology. In particular, DRAM interface 614 operates to convert DRAM signals 612 into signals 619 for interacting with one or more layers 620. DRAM signals 602 can include DRAM control signals, such as column address strobe (“CAS”), row address strobe (“RAS”), and write enable signals (none are shown), address signals representing an address, and data signals representing data either written into or read from one or more layers 620.

As the densities of third dimension memory cells comparable to, or higher than, DRAMs, one or more layers 620 can emulate DRAM technology. One or more layers 620 of third dimension memory cells can provide a “nonvolatile” DRAM, which can conserve power that otherwise would be used to refresh data, such as in refresh cycles common with conventional DRAM. Therefore, any processor implementing emulated DRAM 620 will not lose its data if system clocks are stopped to save power in, for example, sleep mode. As such, emulated DRAM 620 can conserve power when a processor is idle. As third dimension memory elements (or cells) can emulate DRAM memory cells, this reduces external device and board space, as well as pin count.

DRAM interface 614 includes a DRAM interface (“I/F”) controller 616 and optional DRAM interface (“I/F”) buffers 618. DRAM interface controller 616 can include logic configured to use DRAM control signals to determine whether layers 620 in the emulated DRAM memory cells are to be written or read. An example of such logic includes a command state machine configured to decode commands and perform any memory-related function. As such, DRAM interface controller 616 can include additional logic configured to coordinate the conversion of DRAM data and address signals into data and address signals that are useable by memory arrays of third dimension memory cells in layers 620, which emulate DRAM. For example, DRAM interface controller 616 can control the conversion of serially-transmitted commands, data and address signals on a common bus into parallel address and data signals for performing a memory operation with layers 620. Further, DRAM interface controller 616 accommodates relatively longer access times associated with DRAM memory technologies. For example, access times in some DRAM technologies can be about 50 to 60 nanoseconds.

DRAM interface buffers 618 include temporary storage (e.g., using third dimension memory cells in layers 620) for converting serially-transmitted address and/or data signals, if applicable, into parallel address and/or data signals, or vice versa. For example, DRAM interface buffers 618 can latch a serially-transmitted address until it is needed. As another example, if layers 620 are to emulate a DDR SDRAM, DRAM interface buffers 618 can be used to convert serial data signals on rising and falling clock edges to a parallel data signals for layers 620. In view of the foregoing, DRAM interface 614 enables layers 620 to emulate DRAM, for example, at various vertically-stacked layers of memory. This, too, saves memory array space that otherwise would contribute to an increase in die size.

FIG. 6C shows a memory technology-specific interface as a Flash interface 624 configured to use one or more layers 630 of third dimension memory cells to emulate Flash memory technology. In particular, Flash interface 614 operates to convert Flash signals 622 into signals 629 for interacting with one or more layers 630. Flash signals 602 can include Flash control signals, address signals, and data signals representing data either written into or read from one or more layers 630.

Flash interface 624 includes a Flash interface (“I/F”) controller 626 and optional Flash interface (“I/F”) buffers 628, both of which can be configured to operate in a similar manner as those described in FIGS. 6A and 6B. In one embodiment, one or more layers 630 can emulate Flash memory. In this case, Flash interface 624 operates to convert Flash memory-specific signals as Flash signals 622 into signals 629 for interacting with one or more layers 630 that can emulate Flash memory. In at least one instance, the third dimension memory cells can emulate the density and non-volatility of Flash memory. But the third dimension memory cells of one or more layers 630 do not require the erase cycles as does Flash memory, thereby eliminating the time that is otherwise used to erase Flash memory. Hence, a Flash interface composed of Flash interface 624 can be configured to operate at least one of layers 630 as a FLASH memory without a write cycle requiring a preceding erase cycle. Since Flash memory emulation by one or more layers 630 does not require erase cycles, the emulated Flash memory can implement back-to-back writes with no special preconditioning. As such, write operations to the emulated Flash memory are fast and offer enhanced performance. Further, the elimination of erase cycles can also eliminate the need for a Flash file manager, thereby obviating a need for Flash file management software. Thus, one or more layers 630 can operate as Flash memory without a Flash file system. In one embodiment, Flash interface 624 is configured to emulate a NOR-type interface by adapting memory-specific signals for a NOR-type interface for use with layers 630. A NOR-type interface is typically used with Flash memory having a NOR memory structure. In another embodiment, Flash interface 624 is configured to emulate a NAND-type interface to emulate NAND-based Flash memory.

In various embodiments, Flash configuration register 631 can be implemented in third dimension memory cells, such as within or without one or more layers 630, or in any other memory technology.

As third dimension memory cells are nonvolatile in nature, one or more layers 630 can emulate Flash technology. As such, one or more layers 630 can store boot code that otherwise is typically stored in a Flash chip having a separate substrate. By storing boot code internal to a processor-memory system, as described herein, the time to fetch and execute the boot code can be decreased, thereby reducing the time to boot an application. In addition, using one or more layers 630 to emulate Flash memory cells can also reduce the number of external devices, board space and pin count.

FIG. 6D shows a memory technology-specific interface as an “other memory technology” (“OMT”) interface 644 configured to use one or more layers 650 of third dimension memory cells to emulate any other type of memory technology, such as Flash memory, EEPROM, and the like. In particular, OMT interface 644 operates to convert OMT signals 642 into signals 649 for interacting with one or more layers 650. OMT signals 602 can include OMT control signals, address signals, and data signals. OMT interface 644 includes an OMT interface (“I/F”) controller 646 and optional OMT interface (“I/F”) buffers 648, both of which can be configured to operate in a similar manner as those described in FIGS. 6A and 6B.

In one embodiment, one or more layers 650 can emulate EEPROM memory, serial or otherwise. In this case, OMT interface 644 operates to convert EEPROM memory-specific signals as OMT signals 642 into signals 649 for interacting with one or more layers 650. In at least one instance, the third dimension memory cells can emulate the density and nonvolatility of EEPROM memory. But one or more layers 650 perform write operations at lower voltages than EEPROM write operations, thereby obviating a need for applying higher voltages to the third dimension memory cells therein. This eliminates a need for special high voltage charge pumps as well as ASIC fabrication processes that otherwise are conventionally used to form EEPROM cells in a logic subsystem. Also, the third dimension memory cells obviate a need for large capacitors for the voltage pumps, which typically consume surface area of a substrate. For at least the foregoing reasons, emulating EEPROM memory with one or more layers 650 can reduce die area and can improve the reliability of the emulated EEPROM by omitting higher write voltages that typically subject EEPROM cells to stress.

The foregoing examples have been described in some detail for purposes of clarity of understanding, but are not limited to the details provided. There are many alternative ways and techniques for implementation. The disclosed examples are illustrative and not restrictive.

What is claimed is:

1. A memory system, comprising:
a memory including multiple layers of memory cells; and
control logic coupled to the memory, the control logic configured to perform a sanitize operation on at least a portion of the memory,
wherein the sanitize operation writes a plurality of data patterns to a plurality of memory addresses.

2. The memory system of claim 1, wherein the multiple layers of memory cells comprises a third dimensional memory array.

3. The memory system of claim 1, wherein the sanitize operation is further configured to overwrite at least one bit in the plurality of memory addresses.

4. The memory system of claim 1, wherein the control logic performs the sanitize operation without performing an erase operation.

5. The memory system of claim 1 and further comprising:
a sanitize enable pin coupled to the control logic, the sanitize enable pin configured to activate the sanitize operation.

6. The memory system of claim 5, wherein the sanitize enable pin is configured to initiate the sanitize operation on one or more of the multiple layers of memory cells.

7. The memory system of claim 5, wherein the sanitize enable pin is configured to initiate the sanitize operation on a subset of data in one of the multiple layers of memory cells.

8. The memory system of claim 1 and further comprising:
a sanitize complete pin, the sanitize complete pin configured to indicate when the sanitize operation is complete.

9. The memory system of claim 8, wherein the sanitize complete pin further comprises a register configured to store one or more data bits, at least one of which represents whether the sanitize operation is complete.

10. The memory system of claim 1, wherein a read access to the memory is blocked while the sanitize operation is in progress.

11. The memory system of claim 1 and further comprising:
a reset pin, the reset pin configured to provide an activation signal to activate the sanitize operation when the memory receives power.

12. The memory system of claim 11, wherein the reset pin is configured to cause activation of the sanitize operation when an unauthorized user attempts to access the memory.

13. The memory system of claim 1, wherein the plurality of memory addresses to sanitize is determined by a sanitize start address and a sanitize stop address.

14. The memory system of claim 1, wherein the plurality of memory addresses to sanitize is determined by a sanitize start address and a count.

15. The memory system of claim 1, wherein the plurality of memory addresses to sanitize is generated by the control logic.

16. The memory system of claim 1, wherein the control logic is formed in a plane of the third dimensional memory array and the memory is formed in another plane of the third dimensional memory array.

17. The memory system of claim 1, wherein the memory is formed in a non-volatile, two-terminal memory array, the memory array having one or more planes vertically disposed.

18. The memory system of claim 1, wherein the control logic is further configured to perform the sanitize operation in association with the plurality of the memory addresses, in parallel, to sanitize the portion of the memory.

19. The memory system of claim 18, wherein the control logic is further configured to write to the plurality of the memory addresses in parallel.

20. The memory system of claim 18, wherein the portion of the memory includes either the entire memory or portions thereof.

21. An integrated circuit, comprising:
memory cells disposed in multiple layers of memory; and
a memory sanitization circuit configured to sanitize a subset of the memory cells.

22. The integrated circuit of claim 21, wherein the memory sanitization circuit is configured to sanitize the subset of the memory cells without performing an erase operation.

23. The integrated circuit of claim 21, wherein the multiple layers of memory comprise memory elements that are each formed with an electrolytic tunnel barrier and a mixed valence conductive oxide.

24. A memory device, comprising:
a memory, the memory being configured in a third dimensional memory array;
a plurality of pins coupled to the memory, the plurality of pins configured to implement the memory device as an emulated Flash memory-based memory device; and
a sanitizer circuit configured to perform a sanitize operation on at least a portion of the memory,
wherein the sanitize operation excludes an erase cycle.

25. A method of sanitizing memory, comprising:
selecting a layer from a plurality of layers in a memory array, the layer including an identified memory location; and
sanitizing data at the memory location.

26. The method of claim 25, wherein the sanitizing excludes performing an erase operation.

27. The method of claim 25, wherein the sanitizing further comprises one or more of the following:
overwriting data at the memory location with a character;
overwriting data at the memory location with the complement of the character; and
overwriting data at the memory location with a random character,
wherein the overwriting data at the memory location excludes an intervening memory access operation.

28. The method of claim 27, wherein the sanitizing further comprises verifying the data at the memory location is sanitized.
